(19) United States
(12) Patent Application Publication
(10) Pub. No.: US 2016/0117689 A1
(43) Pub. Date: Apr. 28, 2016

(54) PROCESS AND APPARATUS FOR ASSIGNING A MATCH CONFIDENCE METRIC FOR INFERRED MATCH MODELING

(71) Applicant: MasterCard International Incorporated, Purchase, NY (US)

(72) Inventors: Steven Oshry, Tarrytown, NY (US); Luckner Polycarpe, Brooklyn, NY (US); Pamela Veraart, Manhassett, NY (US)

(21) Appl. No.: 14/524,678

(22) Filed: Oct. 27, 2014

(51) Int. Cl. G06Q 30/02; H04L 29/06; G06F 17/30

(52) U.S. Cl. CPC G06Q 30/0201; G06F 17/30386; H04L 63/04

(57) ABSTRACT

Systems, methods, means, computer program code and computerized processes include receiving a first set of de-identified transaction data from a first transaction data source, receiving a second set of de-identified transaction data from a second transaction data source, removing data associated with an identifier field for each of the transactions in the first data set to created a de-identified first data set, removing data associated with an identifier field for each of the transactions in the second data set to create a de-identified second data set, and processing the first and second de-identified data sets using a probabilistic engine to establish a linkage between data in each data set. The probabilistic engine may assign probability scores to pairs of data profiles based on two-way matching of transactions and based at least partly on matching of transactions to nearest neighbors.

### FIELD

Embodiments relate to transaction processing systems and methods. More particularly, embodiments relate to the matching and analysis of transaction data from different sources without exposing any personally identifiable information.

### BACKGROUND

Payment processors, networks and other entities create and process large amounts of spending and payment-related data each day. The data is collected and stored to support transaction processing, and other purposes related to ensuring that parties involved in a transaction are properly compensated. The data has other potential uses as well, including for use in identifying and analyzing spending patterns and behaviors. However, when the payment data is used for such analysis purposes, it is important that the transaction details be “de-identified” from any private or personally identifiable information, or that strict limitations on use of and access to the data must be maintained.

It would be desirable to provide systems and methods which allow the analysis of large volumes of transaction data using de-identified data sets. Further, it would be desirable to provide a linkage method between data from one data source (such as a merchant's sales ledger) to transaction data from a second data source (such as a payment network), thereby providing an ability to construct analyses, reports and other applications based on the matched data sets.

### BRIEF DESCRIPTION OF THE DRAWINGS

FIG. 1 illustrates a system architecture within which some embodiments may be implemented.

FIG. 2 is a flow diagram depicting a process pursuant to some embodiments.

FIG. 3 is a flow diagram depicting a process pursuant to some embodiments.

FIGS. 4A and 4B are block diagrams depicting data tables pursuant to some embodiments.

FIG. 5 is a block diagram depicting a matching table pursuant to some embodiments.

FIG. 6 is a block diagram depicting a portion of an example output analysis pursuant to some embodiments.

FIG. 7 is a block diagram depicting a computer system that may form part of the system shown in FIG. 1.

FIGS. 8-14 are data tables that illustrate an example calculation of a probability score based on simulated transaction data.

FIG. 15 is a flow chart that more formally illustrates a process provided in accordance with aspects of the present invention to calculate probability scores.

FIG. 16 is a diagram that schematically illustrates an aspect of the process of FIG. 15.

### DETAILED DESCRIPTION

Embodiments of the present invention relate to systems and methods for analyzing transaction data. More particularly, embodiments relate to systems and methods for analyzing transaction data using data from a first transaction data provider (e.g., such as a payment card network) and data from a second transaction data provider (e.g., such as a merchant or group of merchants) in a way which ensures that personally identifiable information (“PII”) is not revealed or accessible during or after the analysis.

A number of terms are used herein. For example, the term “de-identified data” or “de-identified data sets” are used to refer to data or data sets which have been processed or filtered to remove any PII. The de-identification may be performed in any of a number of ways, although in some embodiments, the de-identified data may be generated using a filtering process which removes PII and associates a de-identified unique identifier (or de-identified unique “ID”) with each record (as will be described further below).

The term “payment card network” or “payment network” is used to refer to a payment network or payment system such as the systems operated by MasterCard International Incorporated, or other networks which process payment transactions on behalf of a number of merchants, issuers and cardholders. The terms “payment card network data” or “network transaction data” are used to refer to transaction data associated with payment transactions that have been processed over a payment network. For example, network transaction data may include a number of data records associated with individual payment transactions that have been processed over a payment card network. In some embodiments, network transaction data may include information identifying a payment device or account, transaction date and time, transaction amount, and information identifying a merchant or merchant category. Additional transaction details may be available in some embodiments.

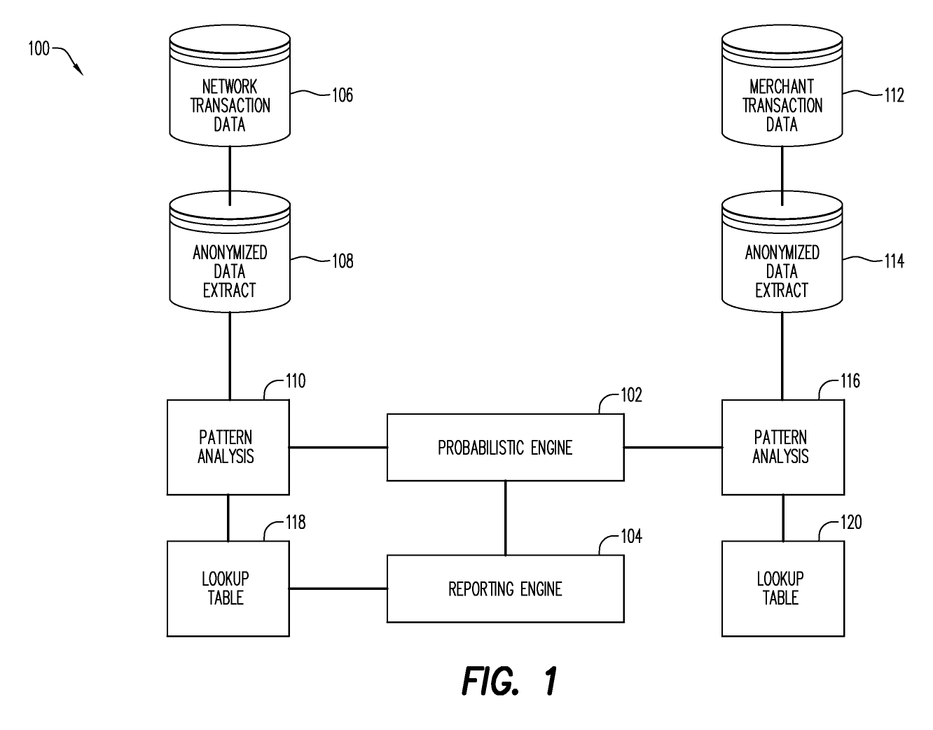

Features of some embodiments of the present invention will now be described by first referring to FIG. 1 where a block diagram of portions of a transaction analysis system 100 are shown. The transaction analysis system 100 may be operated by or on behalf of an entity providing transaction analysis services. For example, in some embodiments, system 100 may be operated by or on behalf of a payment network or association (e.g., such as MasterCard International Incorporated) as a service for entities such as member banks, merchants, or the like.

System 100 includes a probabilistic engine 102 in communication with a reporting engine 104 to generate reports, analyses, and data extracts associated with data matched by the probabilistic engine 102. In some embodiments, the probabilistic engine 102 receives or analyzes data from several data sources, including network transaction data 106 (e.g., from payment transactions made or processed over a payment card network) and merchant transaction data 112 (e.g., from purchase transactions conducted at one or more merchants). The data from each data source 106, 112 is pre-processed before it is analyzed using the probabilistic engine 102. In some embodiments, the data is used to first create an anonymized data extract 108, 114 in which any PII is removed from the data. Pursuant to some embodiments, the anonymized data extract 108, 114 is created by generating a de-identified unique identifier code that is derived from a unique transaction identifier of each transaction in the source data 106, 112. For example, with respect to the network transaction data 106, a function may be applied to a transaction identifier associated with each transaction and transaction record to create a de-identified unique identifier associated with each transaction. In some embodiments, the function may be a hash function or other function so long as the unique identifier cannot by itself be linked to the individual transaction record (for example, an entity that has access to the anonymized data extract 108 is not able to identify any PII associated with a de-identified unique identifier in the extract 108).

The merchant transaction data 112 may be provided to an entity operating the system of the present invention via a secure file transfer (e.g., via sFTP or the like) and associated with a unique merchant identifier. The merchant transaction data 112 may include sales ledger data in a pre-defined format that contains information associated with a plurality of transactions conducted at the merchant including, for example, transaction date/time/spend, store location and a unique identifier associated with the transaction (such as, for example, a customer unique identifier). In some embodiments, the customer unique identifier (“UID”) is selected such that it is not personally identifiable (although it may be personally identifiable with additional information known to the merchant). The customer UID, in some embodiments, is delivered using a de-identified unique identifier generated from the transaction data received from the merchant point of sale systems for continuity between transactions, and is selected to be persistent across transactions. For example, the customer UID may show up numerous times throughout a file provided by a merchant (e.g., the UID may be associated with transactions performed at different store locations, at different times, and with different transaction amounts). In some embodiments, the merchant data extract is tender agnostic, and includes transactions conducted with cash, payment cards, or the like. In general, the number of merchant transactions in the merchant data extract should be higher than the number of payment network transactions extracted by data extract 108 for the merchant as the merchant data extract includes transactions conducted with different tenders including payment network transactions.

Pursuant to some embodiments, the type of data extracted by modules 108, 114 depends on the type of information to be analyzed by the system 100. For example, the data extract 108 may be an extract of the same type of information to be provided by a merchant in data extract 114 (e.g., such as transaction date and time, transaction amount, store location and frequency data). In some embodiments, the data extract may be a sample of a larger set of data, or it may be an entire data set. Further, when extracting payment network data (at 108), information associated with the merchant for which an analysis is to be performed may be used to limit the extract. For example, if an analysis is to be performed for a specific merchant, the extract 108 may be limited to transactions performed at that specific merchant (including all locations or all locations in a specific geographical region). As a specific illustrative example, extract 108 may include a number of records of data, each including a de-identified unique ID, a transaction date, a transaction time, a transaction amount or spend, a store location identifier (identifying a specific store or merchant location), and an aggregate merchant identifier (identifying a specific merchant chain or top level identifier associated with a merchant). Those skilled in the art, upon reading this disclosure, will appreciate that other data fields may also be included depending on the nature of the analysis to be performed.

With respect to the data extract 114 of merchant transaction data 112, in some embodiments, the extract retrieves data elements including a customer UID, a transaction date, a transaction time, a transaction spend, and a store location ID (although those skilled in the art will appreciate that additional or other fields may be extracted depending on the nature of the analysis to be performed).

In some embodiments, the function or process of generating an anonymized data extract 108, 114 may be performed by an entity providing the data. For example, the anonymized data extract 108 may be generated by, or on behalf of, the payment association or the payment network and provided as an input or batch file to an entity operating system 100. As another example, the anonymized data extract 114 may be generated by, or on behalf of, a merchant (or group of merchants) wishing to receive reports or analyses from the system 100.

The system 100 also includes pattern analysis modules 110, 116. Pattern analysis modules 110, 116 may include data, rules or other criteria which define different patterns identified for analysis. Each pattern may be identified by a unique pattern identifier which may be, for example, a random number. Each pattern may be a unique pattern of date/time/spend, store location, and transaction frequency (or other combinations of data for which pattern analysis is desired). The pattern analysis modules 110, 116 may be code or applications which are designed for pattern analysis or may be part of an analysis system or module.

In use, pattern analysis module 110 generates a file, table or other extract of data that is used as an input to the probabilistic engine 102 and which is based on the anonymized and extracted network transaction data. The pattern analysis module 110 may be operated to generate a file, table or other extract of data that includes a number of transactions filtered by an aggregate merchant identifier (e.g., a group of transactions associated with a particular merchant or retail chain across different stores or locations). The module 110 may also summarize and profile the data by each unique combination of transaction date/time/spend, location, and frequency. A new profile identifier may be assigned for each pattern, and the data provided for input to the probabilistic engine 102 may have the de-identified unique ID removed before provision to the engine 102. In some embodiments, the removed unique ID and the assigned profile identifier may be stored in a separate lookup table 118 for later use by the reporting engine 104.

The pattern analysis module 116 generates a file, table or other extract of merchant transaction data that is used as an input to the probabilistic engine 102 and which is based on the anonymized and extracted merchant transaction data provided by module 114. The pattern analysis module 116 may be operated to generate a file, table or other extract of data which has been cleansed to ensure standard formatting of the merchant data for use by the probabilistic engine 102. The cleansing may include the removal of any unnecessary data provided by the merchant. For example, in one specific embodiment, the merchant data may be cleansed to remove all fields other than a customer UID, a transaction date, a transaction time, a transaction spend, and a location ID. The pattern analysis module 116 may further operate to summarize the data by UID to ascertain a frequency of transactions in the merchant data file, and to further summarize and profile data by each combination of transaction date/time/spend, location, and frequency. Upon generation of the extract, a new merchant profile identifier may be assigned to the extract. The merchant profile identifier and the UID are removed from the file output from the pattern analysis module 116. A separate lookup table 120 may be created to store the dropped UID and the merchant profile identifier for later use by the reporting engine 104.

Pursuant to some embodiments, the probabilistic engine 102 operates to perform an inferred match analysis to assess the inferred linkage for uniqueness and direct linkage. This allows further assurance of anonymity and avoids use of any PII. Pursuant to some embodiments, a uniqueness probability is derived from the relationship between the number of unique IDs for the Network Profile and the unique Merchant Profiles. As the probability of a direct link, (driven by uniqueness), approaches 100%, the risk of divulging or revealing some PII increases. For data analysis to identify product or marketing effectiveness, a pattern match of 100% is ideal. However, as the uniqueness of the match approaches 0%, the product or marketing effectiveness decreases significantly. By using features of the present invention to identify the uniqueness probability using anonymized transaction data, embodiments allow marketers, product developers, and analysts to identify trends or actual patterns and to adjust marketing, product development and other features accordingly.

In general, as used herein, the term “direct linkage” refers to the relationship between the probability match and the uniqueness probability. 100% “direct linkage” occurs when the probability match is 100% and the uniqueness probability is 100%. To avoid potentially revealing PII, in some embodiments, it may be desirable to reject any matches where there is 100% direct linkage. Pursuant to some embodiments, the primary inferred match is those records having the highest probabilities within a predetermined acceptance range.

Pursuant to some embodiments, the output of the processing performed by system 100 may be an analysis or report which is generated by the reporting engine 104. To facilitate the reporting and to ensure that PII is not divulged, the reporting engine may use the lookup tables 118, 120 to assign each de-identified merchant profile (from table 120) to one network profile (from table 118). This ensures that the de-identified customers remain de-identified.

As used herein, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. In addition, entire modules, or portions thereof, may also be implemented in programmable hardware devices such as field programmable gate arrays, programmable array logic, programmable logic devices or the like or as hardwired integrated circuits.

In some embodiments, the modules of FIG. 1 are software modules operating on one or more computers. In some embodiments, control of the input, execution and outputs of some or all of the modules may be via a user interface module (not shown) which includes a thin or thick client application in addition to, or instead of a web browser.

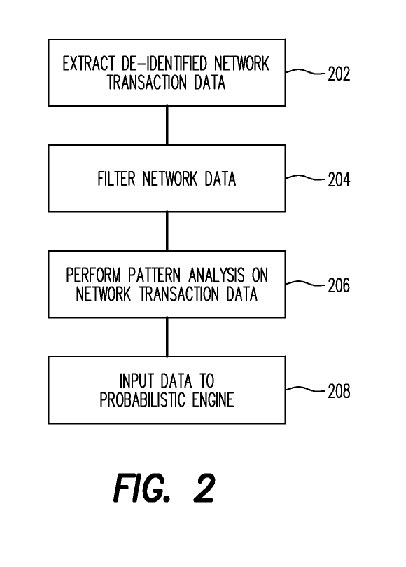

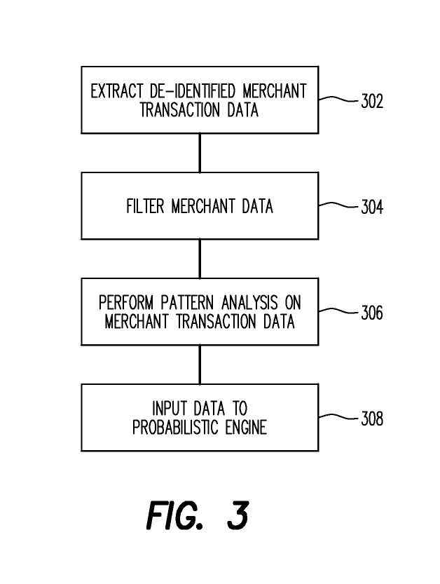

Reference is now made to FIGS. 2-3 which are flow diagrams depicting processes 200, 300 for operating the system 100 of FIG. 1 pursuant to some embodiments. Some or all of the steps of the processes 200, 300 may be performed using under control of the system 100 and may include users or administrators interacting with the system via one or more user devices (not shown).

In the process 200, network transaction data is extracted from a transaction datastore 106 and a pattern analysis is performed to produce a file for input to probabilistic engine 102. The process 200 begins at 202 where a payment network data extract is performed to provide de-identified data from the payment network associated with a particular merchant or group of merchants. The de-identified data extract may include an extract of fields for payment network transactions, including: a de-identified unique ID (generated as described above), an aggregate merchant ID, a transaction date, a transaction time, a transaction spend, and a location ID. In the case where the payment network is the network operated by MasterCard International Incorporated, the data extract will include a number of transactions conducted using MasterCard-branded payment cards.

Processing continues at 204 where the de-identified data extracted at 202 is filtered, producing a filtered output file having a number of transactions for a particular merchant or group of merchants, resulting in a file of payment network transactions conducted at those merchants and each including: a de-identified unique ID, a transaction date, a transaction time, a transaction spend, and a location ID.

Processing continues at 206 where a pattern analysis is performed to identify a frequency of transactions. The pattern analysis may result in the creation of a file including, for each transaction, a de-identified unique ID, a transaction date, a transaction time, a transaction spend, a location ID, and a frequency variable.

Processing continues at 208 where data is provided to the probabilistic engine 102 including a number of transactions each including a number of fields such as: transaction date, transaction time, transaction spend, a location ID, a frequency variable, and a profile ID. The profile ID is associated with an entry in a lookup table created to store the profile ID in association with the de-identified unique ID for each transaction. In this way, data may be input to the probabilistic engine 102 without any identifier (e.g., the de-identified unique ID is removed from the data input to the probabilistic engine 102, and instead a lookup is provided external to the probabilistic engine 102).

Similar processing is performed on the merchant data. For example, as shown in FIG. 3, a process 300 is performed which starts at 302 with the extraction of de-identified merchant data, including a number of transactions (across different tenders) conducted at the merchant. The transaction data includes: a customer UID, a transaction date, a transaction time, a transaction spend, a location identifier, and, in some embodiments, a tender flag (which identifies the form of tender used in each transaction).

The data extract from 302 is then filtered and cleansed at 304 to produce a data file including, for each transaction in the extract, a customer UID, a transaction date, a transaction time, a transaction spend and a location ID.

Processing continues at 306 where the filtered data from 304 is processed using a pattern matching system to derive frequency data associated with the filtered and extracted merchant data. The pattern matching causes the creation of a file having, for each transaction, a customer UID, a transaction date, a transaction time, a transaction spend, a location ID and a frequency variable. A portion of this data is provided as the merchant input to the probabilistic engine 102 at 308, including, for each transaction, a transaction date, a transaction time, a transaction spend, a location ID, a frequency, and a merchant profile ID. The merchant profile ID is associated with a lookup table that is created to associate the customer UID with the pattern or data output at 306. In this way, merchant transaction data may be input to the probabilistic engine 102 without any customer identifier (e.g., the customer UID is removed from the data input to the probabilistic engine 102, and instead a lookup is provided external to the probabilistic engine 102).

By providing such anonymized data to the probabilistic engine 102, a number of analyses and reports may be generated without revealing any PII or other sensitive information. For example, the probabilistic engine 102 may be operated to establish a linkage between a merchant's sales ledger and the de-identified payment network transaction data. The linkage is a probability score between the merchant data and the payment network transaction data based upon spending patterns provided by the merchant along with spending patterns observed in the payment network transaction data. The linkage, on its own, does not necessarily provide any intrinsic value; however, the inferred match is a necessary component to build out merchant applications by providing a link (on a transaction level) between a merchant data file and a payment network data file. As a result, merchants may enjoy the use of a number of analytic and modeling applications including the ability to generate aggregate reports, probability scores and model algorithms.

The two inputs provided to the probabilistic engine 102 include profiles at the network profile level (from pattern analysis 110) and profiles at the merchant profile level (from pattern analysis 116). The profiles may range in quantity of unique accounts (e.g., unique records associated with an account, or the like) from x to 1, and unique transactions from >x to 1.

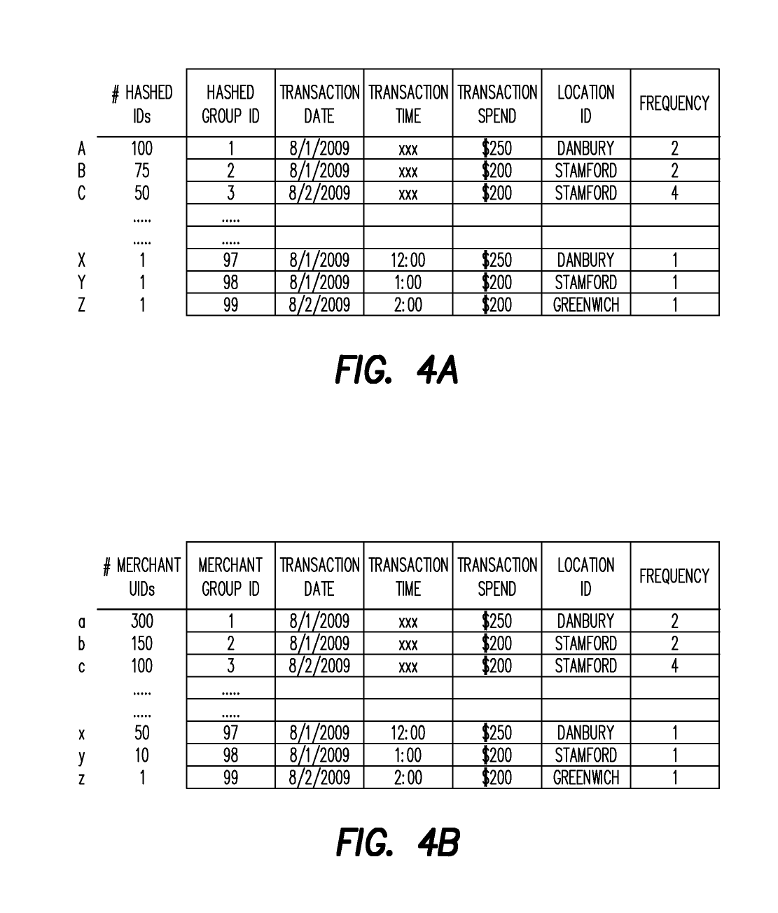

An illustrative example of a portion of data associated with a network profile is shown in FIG. 4A, and FIG. 4B illustrates a portion of data associated with an example table showing a profile at the merchant profile level pursuant to some embodiments.

Pursuant to some embodiments, the probabilistic engine 102 operates to match the merchant profile data with the network profile data with some level of probability. The level of probability, as used herein, is referred to “the pattern match”. The pattern match could range from 0 to 1 (i.e., 0 to 100%). In addition to the pattern match, the probability of uniqueness could range from 0 to 1.

Network profiles and merchant profiles are linked in a many-to-many fashion and given some level of probability for each pattern match (e.g., 100 network profiles and 100 merchant profiles result in 10,000 probabilities). The match may not be exact—for example, the network profile may say that the spending associated with a specific transaction involved a credit card payment, while the merchant record may have a profile that indicates that the transaction was a cash transaction. These discrepancies may be matched and assigned a match probability. The linking is not actual—instead, a probability match is assigned ranging from 0 to 1 for each combination of records. An illustration of the many-to-many pattern match is shown in FIG. 5. In the illustrative example of FIG. 5, a match analysis is shown associated with an analysis performed using the system of FIG. 1 where the network transaction data is from a specific payment network—the network operated by MasterCard International Incorporated. In the illustrative match shown in FIG. 5, a “MasterCard Profile A” matches to a “Merchant Profile a” with a probability of 100%. Further, “Profile B” matches to “Profile b” with a probability of 100%, and so forth, because the patterns are identical. Other combinations are not identical, and therefore have a match probability of less than 100%.

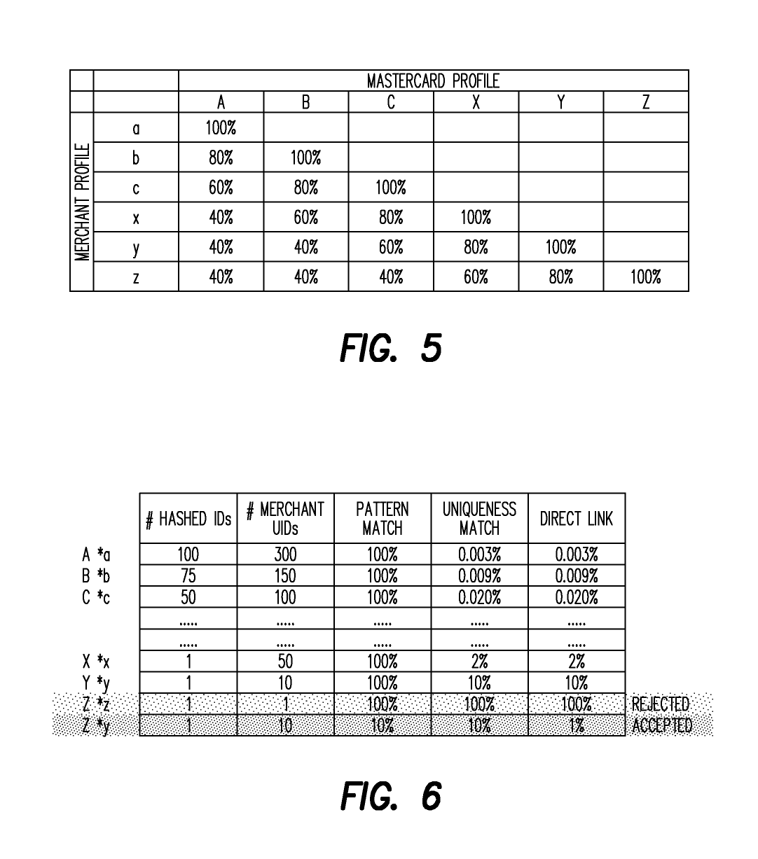

FIG. 6 illustrates an example output of the inferred match process pursuant to some embodiments. The probabilities and acceptance scores are purely for illustrative purposes and are not intended to be limiting. The output of the inferred match process may be produced or manipulated by the reporting engine 104 for use by other applications.

Pursuant to some embodiments, the operation of the system 100 may be based on several assumptions or rules to protect PII. Such assumptions or rules may include ensuring that the combined data set (including network data and merchant data) is not disclosed to the merchant, all applications are specific to a merchant and are not to be shared with other parties, algorithms or scores are created using matched data and no algorithm or score is created using single transaction matches.

Pursuant to some embodiments, the techniques described above may be used in conjunction with a number of different applications. For example, in one embodiment, an aggregated report is produced based on a merchant data file, with an inferred match modeling link to different merchant unique identifiers. In some embodiments, enhanced and aggregated reports may be produced, with inferred match links to merchant unique identifiers utilizing additional “SKU” data from the merchant (e.g., where the SKU level data is received in the merchant transaction data at 112). In some embodiments, data append services may be delivered at the de-identified merchant unique identifier level. Data may be produced as an aggregated metric/probability score. Further, pursuant to some embodiments, an algorithm may be provided designed to score a list outside of a payment network (e.g. for or about a merchant or other third party).

Thus, embodiments of the present invention allow merchants, networks, and others to accurately generate and investigate transaction profiles, without need for added controls to protect and secure PII. Although a number of “assumptions” are provided herein, the assumptions are provided as illustrative but not limiting examples of one particular embodiment—those skilled in the art will appreciate that other embodiments may have different rules or assumptions.

Pursuant to some embodiments, systems, methods, means, computer program code and computerized processes are provided to generate inferred match or linkage between de-identified data in different transaction data sets. In some embodiments, the systems, methods, means, computer program code and computerized processes include receiving a first set of de-identified transaction data from a first transaction data source, receiving a second set of de-identified transaction data from a second transaction data source, filtering the first and second sets of de-identified transaction data to identify transactions associated with at least a first entity and to create first and second filtered data sets, removing data associated with an identifier field for each of the transactions in the first filtered data set to created a de-identified first data set, removing data associated with an identifier field for each of the transactions in the second filtered data set to create a de-identified second data set, and processing the first and second de-identified data sets using a probabilistic engine to establish a linkage between data in each data set.

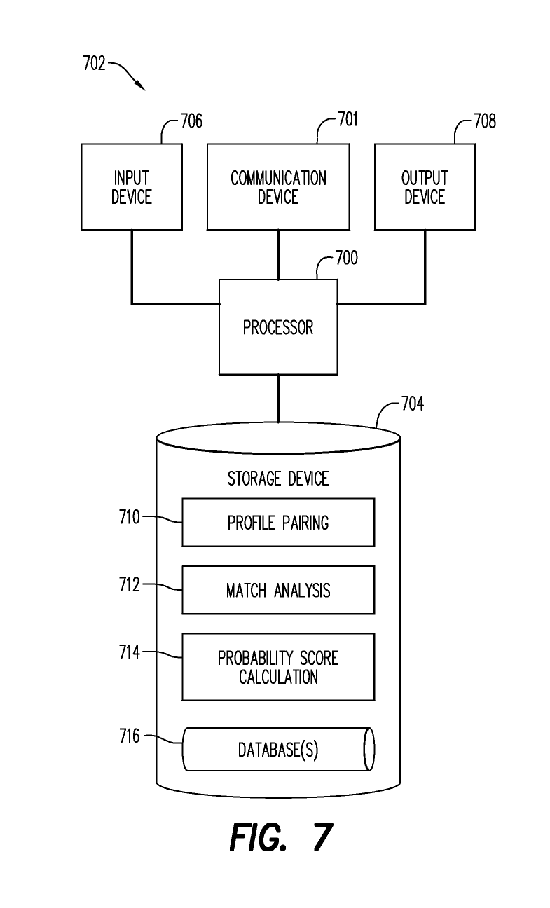

FIG. 7 is a block diagram depicting a computer system 702 that may form part of the system 100 shown in FIG. 1. The computer system 702, in particular, may implement an embodiment of the probabilistic engine 102 shown in FIG. 1. In some embodiments, the computer system 702 may implement other processing functions of the system 100 in addition to the probabilistic engine 102.

The computer system 702 may be conventional in its hardware aspects but may be controlled by software to cause it to operate in accordance with aspects of the present invention. For example, the computer system 702 may be constituted, at least in part, by conventional mainframe and/or server computer hardware.

The computer system 702 may include a computer processor 700 operatively coupled to a communication device 701, a storage device 704, an input device 706 and an output device 708. The storage device 704, the communication device 701, the input device 706 and the output device 708 may all be in communication with the processor 700.

The computer processor 700 may be constituted by one or more conventional processors. Processor 700 operates to execute processor-executable steps, contained in program instructions described below, so as to control the computer system 702 to provide desired functionality.

Communication device 701 may be used to facilitate communication with, for example, other devices (such as one or more other components of the system 100 shown in FIG. 1). Communication device 701 may, for example, have capabilities for engaging in data communication over conventional computer-to-computer data networks.

Input device 706 may comprise one or more of any type of peripheral device typically used to input data into a computer. For example, the input device 706 may include a keyboard and a mouse. Output device 708 may comprise, for example, a display and/or a printer.

Storage device 704 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory.

Storage device 704 stores one or more programs for controlling processor 700. The programs comprise program instructions that contain processor-executable process steps of computer system 702, including, in some cases, process steps that constitute processes provided in accordance with principles of the present disclosure, as described in more detail below.

The programs may include one or more conventional operating systems (not shown) that control the processor 700 so as to manage and coordinate activities and sharing of resources in the computer system 702, and to serve as a host for application programs (described below) that run on the computer system 702.

The programs stored in the storage device 704 may also include a program or program module 710 that controls the processor 700 to enable the computer system 702 to assemble pairs of profiles, where each of the profile pairs consists of one merchant profile and one network profile. For example, as will be understood from the above discussion of FIG. 5, each data cell in FIG. 5 represents one such profile pair. In addition, the storage device 704 may store a program or program module 712 that controls the processor 700 to enable the computer system 702 to analyze each profile pair to determine to what extent there is matching of transactions between the two profiles in the profile pair.

Still further, the storage device 704 may a store an program or program module 714 that controls the processor 700 to enable the computer system 702 to generate the above referenced match probabilities (as seen in FIG. 5), which will also sometimes be referred to as the “probability score” that applies to the respective profile pair. Details of this program/program module 714 will be described below.

The storage device 704 may also store, and the computer system 702 may also execute, other programs, which are not shown. For example, such programs may include a reporting application, which may respond to requests from system administrators for reports on the activities performed by the computer system 702. The other programs may also include, e.g., one or more data communication programs, a database management program, device drivers, etc.

Reference numeral 716 in FIG. 7 indicates one or more databases that are maintained by the computer system 702 on the storage device 704. Among these databases may be databases of merchant profiles, network profiles, and profile pairs with appended probability scores.

The application programs of the computer system 702 as described above, may be combined in some embodiments, as convenient, into one, two or more application programs.

Prior to formally describing a process for calculating probability scores for profile pairs as performed by the computer system 702 in accordance with aspects of the present disclosure, there will first be described a somewhat simplified example of calculating a probability score in accordance with that process, based on a set of simulated merchant and network transaction data.

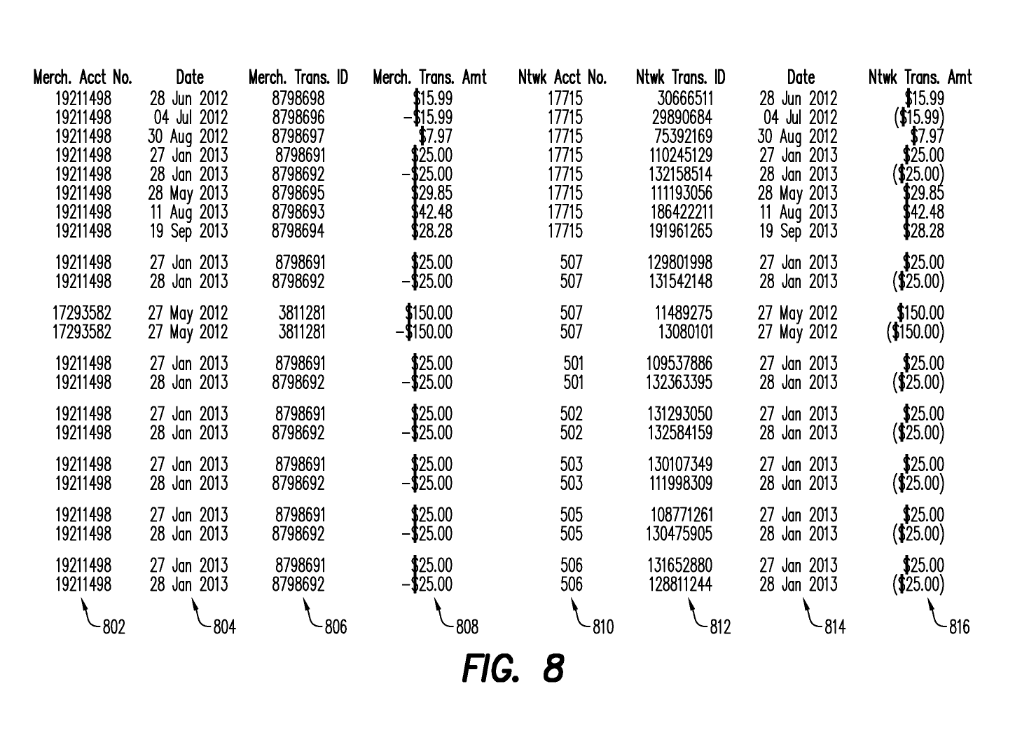

FIGS. 8-14 are data tables that illustrate this example calculation of a probability score based on simulated transaction data.

In particular, FIG. 8 shows an example of matched transaction data relevant to a profile pair that corresponds to a merchant profile for merchant account no. 19211498 (which may alternatively be a unique ID applied to the merchant profile to mask the customer's identity) paired with a network profile for network account no. 17715 (which may alternatively be a hash ID no. applied to the network profile to mask the customer's identity).

Each row in the data table shown in FIG. 8 corresponds to a respective matching of a merchant transaction with a network transaction based on transaction amount and transaction date. Column 802 corresponds to the merchant account no. for the transaction match. Column 804 corresponds to the date of the merchant transaction in question. Column 806 corresponds to the transaction identifier for the merchant transaction in question. Column 808 corresponds to the amount of the merchant transaction in question. Column 810 corresponds to the network account no. for the transaction in question. Column 812 corresponds to the transaction identifier for the network transaction in question. Column 814 corresponds to the date of the network transaction in question. Column 816 corresponds to the amount of the network transaction in question.

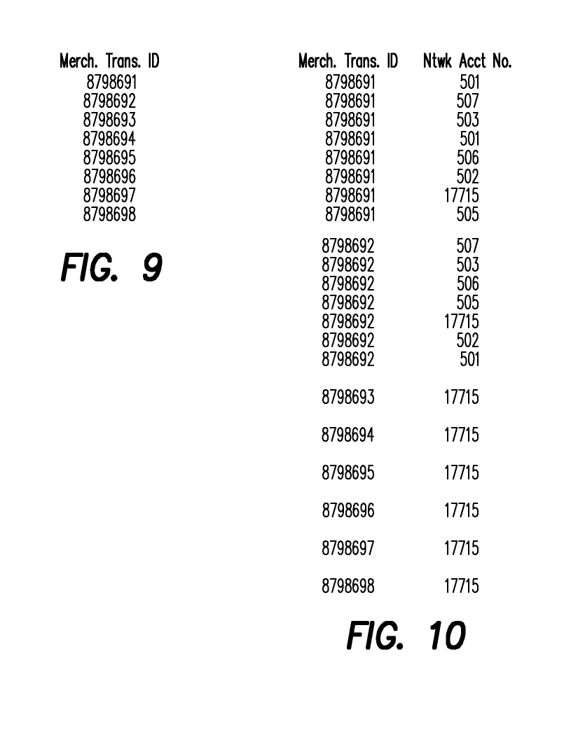

FIG. 9 shows a list of the transaction identifiers for the merchant transactions included in the merchant profile that is included in the profile pair in question.

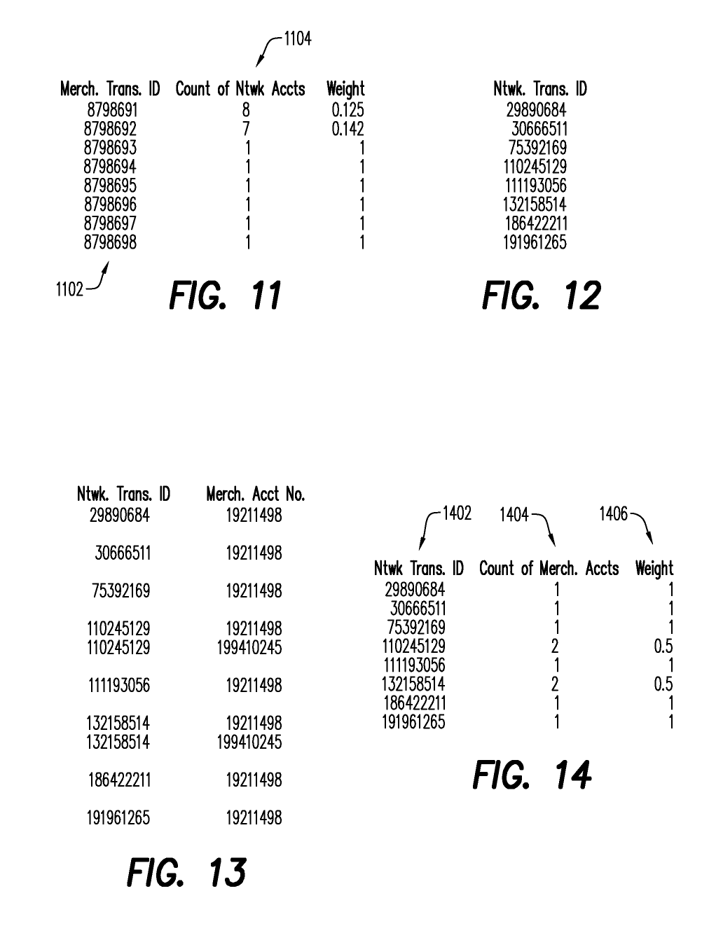

FIG. 10 illustrates a listing of each of the merchant transactions with network profiles that include a network transaction that matches the merchant transaction in question. It will be noted that merchant transaction 8798691 is matched to eight network profiles; merchant transaction 8798692 is matched to seven network profiles; and the remaining six merchant transactions are each matched to one network profile (namely the network profile no. 17715 included in the profile pair in question). FIG. 11 shows a compilation of the information contained in the previous sentence, including the merchant transaction identifier in column 1102, and the corresponding count of matching network profiles in column 1104. In addition, in column 1106 there is shown the calculated reciprocal of the corresponding count value in column 1104. The reciprocal values are used as weights to be assigned to each corresponding merchant transaction in the merchant profile in the current profile pair. The weights are summed to produce a weight sum value, which in this particular case equals 6.3 (with rounding). This weight sum is divided by the count of the merchant transactions, which in this case is eight, leading to the calculation 6.3÷8=0.786=78.6%. This is the merchant transaction match percentage for the probability score calculation.

FIG. 12 shows a list of the transaction identifiers for the network transactions included in the network profile that is included in the profile pair in question.

FIG. 13 illustrates a listing of each of the network transactions with merchant profiles that include a merchant transaction that matches the network transaction in question. FIG. 13 shows network transaction 110245129 and network transaction 132158514 each matched to two merchant profiles apiece, with the remaining six network transactions each matched to one merchant profile (namely the merchant profile no. 19211498 included in the profile pair in question). FIG. 14 shows a compilation of the information contained in the previous sentence, including the network transaction identifier in column 1402, and the corresponding count of matching merchant profiles in column 1404. In a corresponding manner to FIG. 11, in column 1406 of FIG. 14 there is shown the calculated reciprocal of the corresponding count value in column 1404. The value in column 1406 is used as a weight to be assigned to each corresponding network transaction in the network profile in the current profile pair. These weights are summed to produce a weight sum value, which in this case (for the network profile) equals 7. This weight sum is divided by the count of the network transactions, which in this case is eight, leading to the calculation 7÷8=0.875=87.5%. This is the network transaction match percentage for the probability score calculation.

In a final stage of the process, an average (mean) is calculated of the two match percentages, which is this case yields the calculation (78.6%+87.5%)/2=83.0%. The latter result is the probability score to be assigned to the profile pair in question (which in this case is [merchant profile no. 19211498; network profile no. 17715]). The probability score may serve as a match confidence metric relative to proposed matching of the merchant profile to the network profile.

It will be noted that this embodiment of the probabilistic engine 102 works with two-way matching between network and merchant profiles, and may also base its calculations in part on matching of transactions to “nearest neighbor” profiles. A nearest neighbor profile, relative to a particular profile pair, is either (a) a network profile not included in the profile pair and having a transaction that matches a merchant transaction included in the merchant profile included in the profile pair, or (b) a merchant profile not included in the profile pair and having a transaction that matches a network transaction included in the network profile in the profile pair.

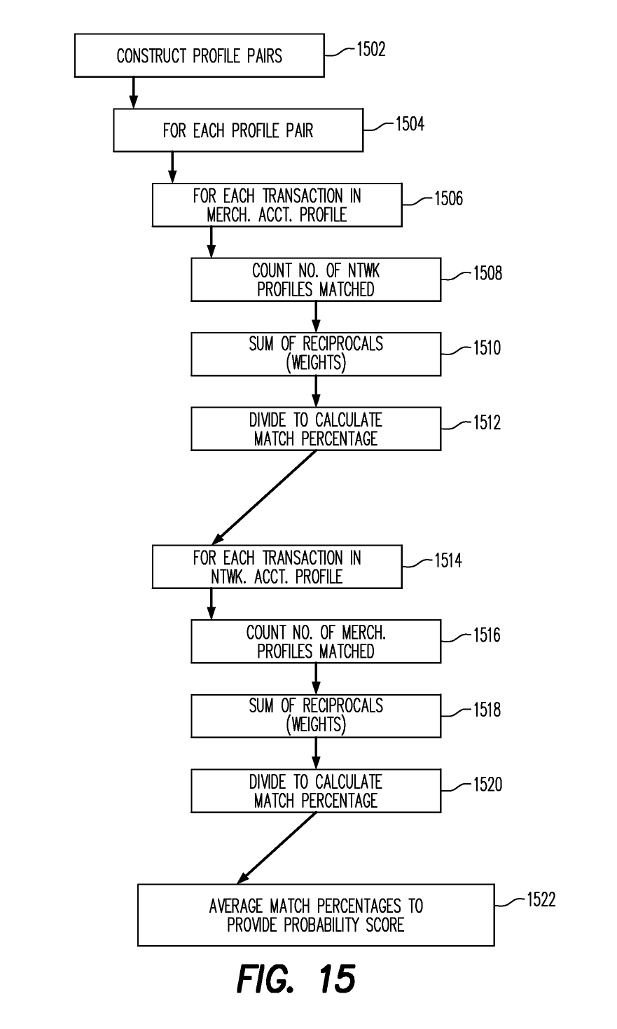

There will now be a more formal description of the process illustrated in one simulated example by FIGS. 8-14. The more formal description will be made with reference to FIG. 15. FIG. 15 is a flow chart that illustrates a process that may be performed by the computer system 702/probabilistic engine 102 in accordance with aspects of the present invention.

At 1502 in FIG. 2, the computer system 702 assembles profile pairs, each of which consists of one merchant profile and one network profile. As suggested by prior discussion, in some embodiments, the total number of profile pairs assembled is the number of merchant profiles times the number of network profiles, with each merchant profile matched with each and every network profile to form the profile pairs.

Block 1504 indicates that the subsequent stages of the process of FIG. 15 may be performed for each of the profile pairs, to generate a respective probability score for each of the profile pairs. Thus it can be assumed for the balance of the discussion of FIG. 15 that a particular profile pair has been selected for calculation of a probability score. It will of course be recalled that the profile pair consists of one of the merchant profiles and one of the network profiles. It will also be understood that each merchant profile includes one or more merchant transactions and each network profile includes one or more network transactions.

Block 1506 indicates that the following block 1508 is to be performed for each transaction included in the merchant profile in the current profile pair. At block 1508, for the current merchant transaction, the computer system 702 counts the number of network profiles that are matched to the current merchant transaction.

At block 1510, the computer system 702 calculates reciprocals of the counts generated at 1508 for the merchant transactions, and then calculates a sum of the reciprocals, which are assigned as weights to the merchant transactions. The resulting sum may be referred to as a weight sum for the merchant profile for the current profile pair.

Next, at 1512, the merchant profile weight sum is divided by the merchant transaction count, which is the number of merchant transactions included in the merchant profile, and hence associated with the current profile pair. The result of the division operation may be expressed as a percentage, which may be referred to as the merchant transaction match percentage for the current profile pair.

Block 1514 indicates that the following block 1516 is to be performed for each transaction included in the network profile in the current profile pair. At block 1516, for the current network transaction, the computer system counts the number of merchant profiles that are matched to the current network transaction.

At block 1518, the computer calculates reciprocals of the counts generated at 1516 for the network transactions, and then calculates a sum of the reciprocals, which are assigned as weights to the network transactions. The resulting sum may be referred to as a weight sum for the network profile for the current profile pair.

Next, at 1520, the network profile weight sum is divided by the network transaction count, which is the number of network transactions included in the network profile, and hence associated with the current profile pair. The result of the division operation at 1520 may be expressed as a percentage, which may be referred to as the network transaction match percentage for the current profile pair.

At 1522, the computer system 702 computes an average (mean) of the merchant transaction match percentage calculated at 1512 and the network transaction match percentage calculated at 1520. The resulting average may be expressed as a percentage and may be assigned to the current profile pair as the probability score for the current profile pair.

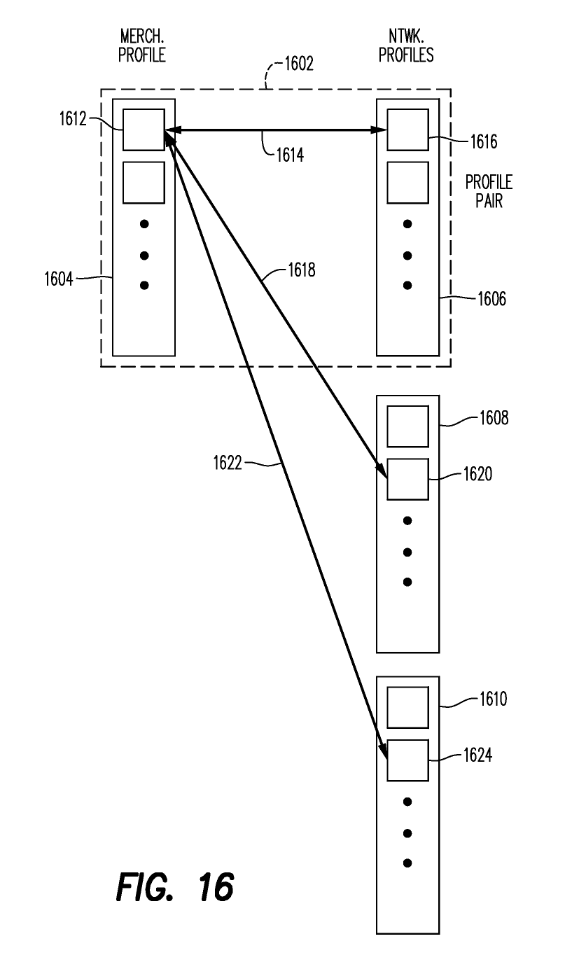

FIG. 16 schematically illustrates the concept of “nearest neighbor” matching that was referred to above. Dashed line block 1602 represents a profile pair, consisting of a merchant profile 1604 and a network profile 1606. Also shown are additional network profiles 1608 and 1610, which are not included in the profile pair 1602.

Merchant profile 1604 includes a merchant transaction 1612. As indicated at 1614, the merchant transaction 1612 matches a network transaction 1616 included in the network profile 1606. In addition, it is indicated at 1618 that the merchant transaction 1612 matches a network transaction 1620 that is included in network profile 1608. Also, it is indicated at 1622 that the merchant transaction 1612 matches a network transaction 1624 that is included in the network profile 1610.

Because each of the network profiles 1608 and 1610 has a transaction that matches a transaction included in the merchant profile 1604 of the profile pair 1602, network profiles 1608 and 1610 are considered nearest neighbors of the network profile 1606 of the profile pair 1602.

The process illustrated by an example in FIGS. 8-14 and described more formally in connection with FIG. 15 will now be briefly summarized working backward from the result of the process, which is the assignment of a probability score to each pair of profiles. As noted above, each profile pair consists of a merchant profile and a network profile.

For a given profile pair, the probability score is the average of a merchant transaction match percentage and a network transaction match percentage.

The merchant transaction match percentage is obtained by dividing a merchant profile weight sum by a merchant transaction count.

The merchant profile weight sum is calculated as the sum of weights each assigned to a respective merchant transaction included in the merchant profile that is included in the profile pair in question. The weight assigned to each merchant transaction in the merchant profile is the reciprocal of the number of network profiles matched to the merchant transaction in question. The merchant transaction count is the number of transactions included in the merchant profile included in the profile pair in question and hence associated with the profile pair in question.

The network transaction match percentage is obtained by dividing a network profile weight sum by a network transaction count.

The network profile weight sum is calculated as the sum of weights each assigned to a respective network transaction included in the network profile that is included in the profile pair in question. The weight assigned to each network transaction in the network profile is the reciprocal of the number of merchant profiles matched to the network transaction in question. The network transaction count is the number of transactions included in the network profile included in the profile pair in question and hence associated with the profile pair in question.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A computerized method, comprising:
receiving a first set of de-identified transaction data from a first transaction data source, the first set of de-identified transaction data having all personally identifiable information removed therefrom, the first set of de-identified transaction data representing a plurality of first profiles;
receiving a second set of de-identified transaction data from a second transaction data source, the second set of de-identified transaction data having all personally identifiable information removed therefrom, the second set of de-identified transaction data representing a plurality of second profiles; and
processing said first and second de-identified data using a probabilistic engine to establish a linkage between data in each data set, the linkage being a set of probability scores, each of said probability scores assigned to a respective pair of profiles, each of said pairs of profiles including one of said first profiles and one of said second profiles, at least some of said probability scores based at least in part, for a respective one of said pairs of profiles, on nearest neighbor matches for said respective pair of profiles;
a nearest neighbor match being: (a) a match to a transaction associated with the respective first profile included in the respective pair of profiles by a one of said second profiles that is not included in the respective pair of profiles; or (b) a match to a transaction associated with the respective second profile included in the respective pair of profiles by a one of said first profiles that is not included in the respective pair of profiles.

2. The method of claim 1, wherein:
each of said probability scores is calculated by averaging a first match percentage and a second match percentage;
said first match percentage calculated by dividing a first weight sum by a first transaction count, said first transaction count equal to a total number of transactions of said first data set associated with the first profile included in a respective one of said pairs of profiles;
said first weight sum calculated as a sum of weights each assigned to a respective transaction associated with the first profile included in the respective one of said pairs of profiles;
said weight assigned to each respective transaction associated with the first profile being a reciprocal of a number of said second profiles matched to said each respective transaction associated with the first profile;
said second match percentage calculated by dividing a second weight sum by a second transaction count, said second transaction count equal to a total number of transactions of said second data set associated with the second profile included in the respective one of said pairs of profiles;
said second weight sum calculated as a sum of weights each assigned to a respective transaction associated with the second profile included in the respective one of said pairs of profiles;
said weight assigned to each respective transaction associated with the second profile being a reciprocal of a number of said first profiles matched to said each respective transaction associated with the second profile.

3. The method of claim 1, wherein said first set of transaction data is generated by a merchant, and said second set of transaction data is captured in a payment network.

4. The method of claim 3, further comprising:
prior to said processing step, filtering said second set of transaction data to remove all data not related to transactions involving said merchant.

5. The method of claim 4, wherein:
each of said first profiles is associated with a respective first profile identifier; and
each of said second profiles is associated with a respective second profile identifier.

6. The method of claim 5, wherein:
each of said first profiles is associated with said respective first profile identifier via a first lookup table that contains all of said first profile identifiers; and
each of said second profiles is associated with said respective second profile identifier via a second lookup table that contains all of said second profile identifiers.

7. The method of claim 6, wherein:
each of said first profiles corresponds to a respective customer account maintained by said merchant; and
each of said second profiles corresponds to a respective payment card account.

8. A non-transitory medium having program instructions stored thereon, the medium comprising:
instructions to receive a first set of de-identified transaction data from a first transaction data source, the first set of de-identified transaction data having all personally identifiable information removed therefrom, the first set of de-identified transaction data representing a plurality of first profiles;
instructions to receive a second set of de-identified transaction data from a second transaction data source, the second set of de-identified transaction data having all personally identifiable information removed therefrom, the second set of de-identified transaction data representing a plurality of second profiles; and
instructions to process said first and second de-identified data using a probabilistic engine to establish a linkage between data in each data set, the linkage being a set of probability scores, each of said probability scores assigned to a respective pair of profiles, each of said pairs of profiles including one of said first profiles and one of said second profiles, at least some of said probability scores based at least in part, for a respective one of said pairs of profiles, on nearest neighbor matches for said respective pair of profiles;
a nearest neighbor match being: (a) a match to a transaction associated with the respective first profile included in the respective pair of profiles by a one of said second profiles that is not included in the respective pair of profiles; or (b) a match to a transaction associated with the respective second profile included in the respective pair of profiles by a one of said first profiles that is not included in the respective pair of profiles.

9. The medium of claim 8, wherein:
each of said probability scores is calculated by averaging a first match percentage and a second match percentage;
said first match percentage calculated by dividing a first weight sum by a first transaction count, said first transaction count equal to a total number of transactions of said first data set associated with the first profile included in a respective one of said pairs of profiles;
said first weight sum calculated as a sum of weights each assigned to a respective transaction associated with the first profile included in the respective one of said pairs of profiles;
said weight assigned to each respective transaction associated with the first profile being a reciprocal of a number of said second profiles matched to said each respective transaction associated with the first profile;
said second match percentage calculated by dividing a second weight sum by a second transaction count, said second transaction count equal to a total number of transactions of said second data set associated with the second profile included in the respective one of said pairs of profiles;
said second weight sum calculated as a sum of weights each assigned to a respective transaction associated with the second profile included in the respective one of said pairs of profiles;
said weight assigned to each respective transaction associated with the second profile being a reciprocal of a number of said first profiles matched to said each respective transaction associated with the second profile.

10. The medium of claim 8, wherein said first set of transaction data is generated by a merchant, and said second set of transaction data is captured in a payment network.

11. The medium of claim 10, further comprising:
instructions to filter, prior to said processing, said second set of transaction data to remove all data not related to transactions involving said merchant.

12. The medium of claim 11, wherein:
each of said first profiles is associated with a respective first profile identifier; and
each of said second profiles is associated with a respective second profile identifier.

13. The medium of claim 12, wherein:
each of said first profiles is associated with said respective first profile identifier via a first lookup table that contains all of said first profile identifiers; and
each of said second profiles is associated with said respective second profile identifier via a second lookup table that contains all of said second profile identifiers.

14. The medium of claim 13, wherein:
each of said first profiles corresponds to a respective customer account maintained by said merchant; and
each of said second profiles corresponds to a respective payment card account.

15. An apparatus comprising:
a processor; and
a memory in communication with said processor and storing program instructions, said processor operative with the program instructions to perform functions as follows:
receiving a first set of de-identified transaction data from a first transaction data source, the first set of de-identified transaction data having all personally identifiable information removed therefrom, the first set of de-identified transaction data representing a plurality of first profiles;
receiving a second set of de-identified transaction data from a second transaction data source, the second set of de-identified transaction data having all personally identifiable information removed therefrom, the second set of de-identified transaction data representing a plurality of second profiles; and
processing said first and second de-identified data using a probabilistic engine to establish a linkage between data in each data set, the linkage being a set of probability scores, each of said probability scores assigned to a respective pair of profiles, each of said pairs of profiles including one of said first profiles and one of said second profiles, at least some of said probability scores based at least in part, for a respective one of said pairs of profiles, on nearest neighbor matches for said respective pair of profiles;
a nearest neighbor match being: (a) a match to a transaction associated with the respective first profile included in the respective pair of profiles by a one of said second profiles that is not included in the respective pair of profiles; or (b) a match to a transaction associated with the respective second profile included in the respective pair of profiles by a one of said first profiles that is not included in the respective pair of profiles.

16. The apparatus of claim 15, wherein:
each of said probability scores is calculated by averaging a first match percentage and a second match percentage;
said first match percentage calculated by dividing a first weight sum by a first transaction count, said first transaction count equal to a total number of transactions of said first data set associated with the first profile included in a respective one of said pairs of profiles;
said first weight sum calculated as a sum of weights each assigned to a respective transaction associated with the first profile included in the respective one of said pairs of profiles;
said weight assigned to each respective transaction associated with the first profile being a reciprocal of a number of said second profiles matched to said each respective transaction associated with the first profile;
said second match percentage calculated by dividing a second weight sum by a second transaction count, said second transaction count equal to a total number of transactions of said second data set associated with the second profile included in the respective one of said pairs of profiles;
said second weight sum calculated as a sum of weights each assigned to a respective transaction associated with the second profile included in the respective one of said pairs of profiles;
said weight assigned to each respective transaction associated with the second profile being a reciprocal of a number of said first profiles matched to said each respective transaction associated with the second profile.

17. The apparatus of claim 15, wherein said first set of transaction data is generated by a merchant, and said second set of transaction data is captured in a payment network.

18. The apparatus of claim 17, wherein the processor is further operative with the program instructions to:
prior to said processing step, filter said second set of transaction data to remove all data not related to transactions involving said merchant.

19. The apparatus of claim 18, wherein:
each of said first profiles is associated with a respective first profile identifier; and
each of said second profiles is associated with a respective second profile identifier.

20. The apparatus of claim 19, wherein:
each of said first profiles is associated with said respective first profile identifier via a first lookup table that contains all of said first profile identifiers; and
each of said second profiles is associated with said respective second profile identifier via a second lookup table that contains all of said second profile identifiers.
